(19) United States
(12) Patent Application Publication
(10) Pub. No.: US 2005/0028426 A1
(43) Pub. Date: Feb. 10, 2005

(54) Line splice multi-card with built-in splice assembly tool

(75) Inventors: Russell E. Blette, Hastings, MN (US); John E. Stark, Maplewood, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/939,540

(22) Filed: Sep. 13, 2004

Related U.S. Application Data
(63) Continuation-in-part of application No. 10/628,220, filed on Jul. 28, 2003.

(51) Int. Cl. A01K 91/047

(52) U.S. Cl. 43/43.1

(57) ABSTRACT

A fishing line splice tool includes a card and a lever. The card has a first slot with a first terminus. The lever has a second slot with a second terminus. The second terminus and the first terminus can be aligned along an axis, the axis being substantially perpendicular to both the first slot and the second slot. One method for linear connection of fishing lines includes providing a female connector, providing a male connector, providing the card, inserting an end of the female connector into the first terminus to thereby hold the female connector; and inserting the male connector into the first opening of the female connector. One method further includes providing the lever and inserting an end of the male connector into the second terminus to thereby hold the male connector. One method further includes providing manual force on the lever.

### CROSS-REFERENCE TO RELATED APPLICATION(S)

This application incorporates by reference and claims priority from application Ser. No. 10/628,220, filed Oct. 17, 2003, entitled Line Splice Using Barb and Receiver, by Russell E. Blette, John E. Stark and Jeffrey L. Wieringa.

### BACKGROUND OF THE INVENTION

This invention relates in general to a device and method for linearly connecting strand materials and more particularly to a device which facilitates the connection of fishing lines.

In many types of fishing, and particularly in fly fishing, it is necessary or desirable to linearly connect sections of fishing line, either because of different properties of the sections or to repair a break. A fly fisherman must be equipped with a fishing rod, a fishing line called a fly line, a device such as a reel to hold the fly line, a leader line commonly called a leader, and flies. A leader is a relatively short, fine, tapered segment of monofilament line, with its larger or butt end attached to the fly line and its smaller or terminal end to the fly.

Fly fishing involves casting a line a substantial distance over a body of water wherein only the weight of the line is used to effect the cast. A skilled fly caster typically uses a tapered line and a tapered leader at the end of this line. One of the more difficult aspects of fly fishing involves connecting the end of the leader to the end of the fishing line by tying a knot. The knot must be specially selected to avoid kinks and/or slip-separation of the leader from the line.

Typically, a leader will range from as short as 5 or 6 feet to as long as 12 to 15 feet. Some leaders possess a true taper, that is, they undergo a gradual change in diameter from the butt end to the terminal end without any interruptions in the leader material. Other leaders consist of lengths of varying diameter leader material tied together. Many fishermen favor the latter, that is the knotted leader, in that it enables them to tailor the leader to their own needs. But irrespective of whether the fisherman uses a truly tapered leader or a knotted leader, the fisherman will usually find it necessary to replace the end section or segment of the leader, often called the tippet, for this is where the leader is thinnest and weakest, and where it will break if its capacity is exceeded. Tippet replacement and repair usually require a fisherman to form a knot. Moreover, when a fisherman changes to a smaller fly, a thinner tippet is often required. Hence, the typical fisherman must tie knots from time to time in leader material, which is usually monofilament line.

The knots which join the lengths of leader material either to the fly line or to other leader sections must accommodate the varying diameters of material and must be strong. Nail knots and Albright knots meet these requirement, but are time consuming to tie and require skill, good eyesight and considerable manual dexterity. Moreover, the knot is usually the weakest part of the fish line and may cause the breaking of the fish line at the knot. Thus, there remains a need for a quick and easy device and method for strong linear connection of fishing lines.

### BRIEF SUMMARY OF THE INVENTION

A fishing line splice tool includes a card and a lever. The card has a first slot with a first terminus. The lever has a second slot with a second terminus. The second terminus and the first terminus can be aligned along an axis, the axis being substantially perpendicular to both the first slot and the second slot. One method for linear connection of fishing lines includes providing a female connector, providing a male connector, providing the card, inserting an end of the female connector into the first terminus to thereby hold the female connector; and inserting the male connector into the first opening of the female connector. One method further includes providing the lever and inserting an end of the male connector into the second terminus to thereby hold the male connector. One method further includes providing manual force on the

### BRIEF DESCRIPTION OF THE DRAWINGS

FIG. 1 is perspective view of one embodiment of the splice system of the present invention.

FIG. 2 is a cross-sectional view along line 2-2 of FIG. 1, showing the two connectors of the splice system in a disconnected configuration.

FIG. 3A is a cross-sectional view of another embodiment of a male connector of the splice system.

FIG. 3B is a cross-sectional view of yet another embodiment of a male connector of the splice system.

FIG. 4 is a cross-sectional view of the two connectors of FIG. 2 in a connected configuration.

FIG. 5 is a side elevation view of a card holding multiple female connectors.

FIG. 6 is a partial perspective view of the removal of one female connector from the card of FIG. 5.

FIG. 7 is a partial perspective view illustrating use of a connector holding tool disposed on the card of FIG. 5.

FIG. 8 is a partial perspective view illustrating use of a connector holding tool disposed on the card of FIG. 5 and an alternate method.

FIG. 9 is a perspective view of a card having an attached lever.

FIG. 10 is a perspective view of the card of FIG. 9 with the lever detached therefrom and then assembled onto the card.

FIG. 11 is a perspective view showing one embodiment of a method for assembling the splice system using the lever and card tool.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

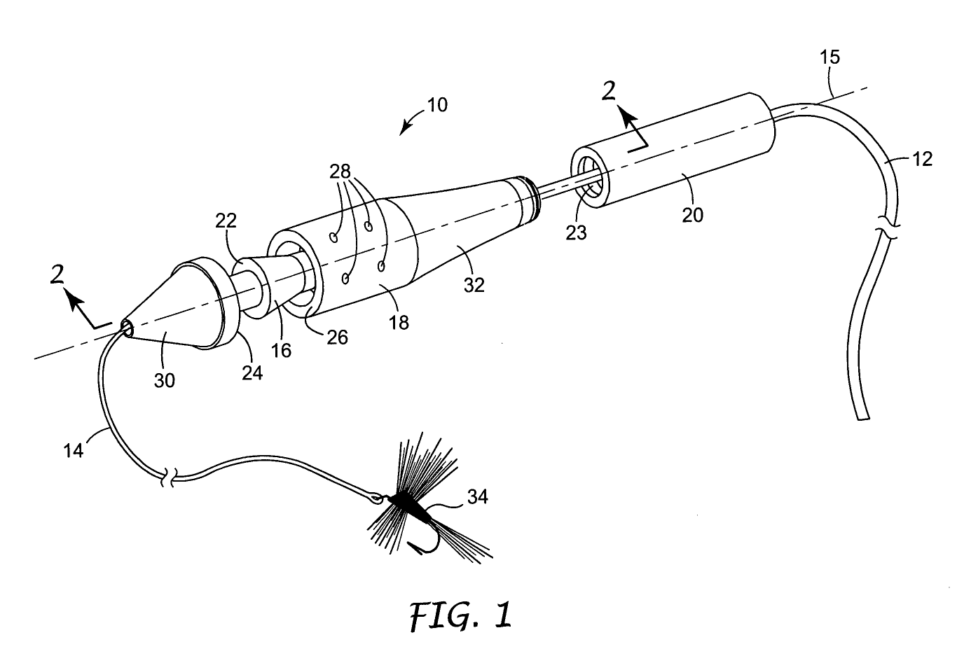

FIG. 1 is perspective view of one embodiment of the splice system of the present invention. Splice system 10 connects fly or fishing line 12 and leader 14 or other fishing line segments along longitudinal axis 15. Splice system 10 includes two main components: male connector or barb 16 and female connector or receiver 18, each of which is symmetric about axis 15. One embodiment additionally includes float 20.

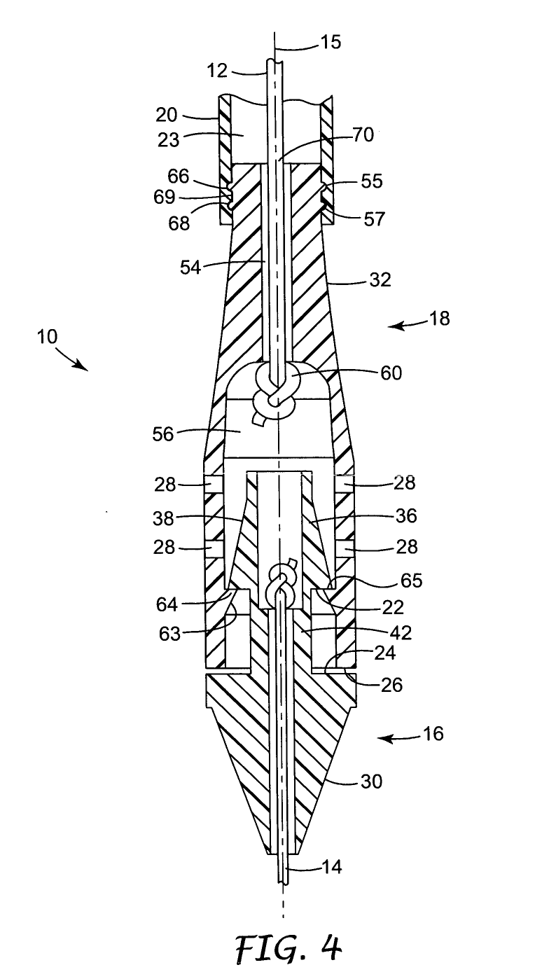

Leader 14 is either permanently or removably secured to barb 16. Fly line 12 is either permanently or removably secured to receiver 18. FIG. 1 illustrates barb 16 partially inserted into, but not yet fully mated with, receiver 18. When barb 16 is fully inserted into receiver 18, flange or radially extending shoulder 22 facilitates a snap connection with an interior feature of receiver 18, forming a permanent, locking connection. When barb 16 and receiver 18 are fully connected (e.g. FIG. 4), radially extending stop surface 24 of barb 16 is disposed adjacent radially extending end surface 26 of receiver 18. In one embodiment, barb 16 and receiver 18 include tapered surfaces 30 and 32, respectively, to enhance the movement of splice system 10 through air and water.

When barb 16 and receiver 18 are fully connected, thereby connecting leader 14 to fly line 12, a fisherman can cast fly line 12 and leader 14 over the water to place fly 34 into the body of water. In an exemplary embodiment, barb 16 and receiver 18 are each molded from a lightweight, resilient and durable material such as plastic or nylon. Nylon 66, available from E.I. DuPont de Nemours and Co., Inc., Wilmington, Del., is used in one suitable embodiment. Polypropylene, which floats in water, is used in another suitable embodiment.

In an exemplary embodiment, a connected system 10 of barb 16 and receiver 18 is less than about 0.75 inch (19.05 mm) long and less than about 0.125 inch (3.2 mm) in diameter. In some embodiments, fly line 12 is about 0.032 inch (0.81 mm) to about 0.042 inch (1.07 mm) in diameter. In some embodiments, leader 14 is about 0.020 inch (0.51 mm) to about 0.026 inch (0.66 mm) in diameter. Splice system 10, with its low profile, small size, light weight, elongated shape and circular cross section is advantageous over other connection methods in that it is easy to use, very small, lightweight, and aero- and hydrodynamic. The shape and size allow a fly line 12 and leader 14 connected by splice system 10 to glide easily through air and water without disrupting the flow of the fishing line in casting. In particular, tapered surface 32 of receiver 18 improves the pick up of splice system 10 off the water and allows for more accurate casting due to the reduction of frictional resistance with respect to the water and air, compared to other splice systems.

In one embodiment, float 20 can be used with splice system 10 to provide buoyancy to the connection. In another embodiment, buoyancy is incorporated into barb 16 and/or receiver 18 by using buoyant materials or adding buoyant features such as dispersed hollow glass beads in the bulk material. Weep orifices 28 in an exemplary embodiment allow for the release of any water that seeps into receiver 18.

In one embodiment, float 20 is formed of a closed-cell or open-cell foam and can be configured as a cylinder having axial bore 23 through which fly line 12 can pass to secure float 20 onto fly line 12. In one exemplary embodiment, float 20 is formed of open-cell foam having a specific gravity of at least about 0.5. In another embodiment, float 20 is formed of extruded open-cell foam having a specific gravity of less than about 0.6. Float 20, when brightly colored, is functional as a strike indicator because it visibly signals movement of the leader and fly during a fish strike.

In some applications, float 20 is not used because a sinking line is preferred. In that case, sinking ingredients such as tungsten powder can be incorporated into barb 16 and/or receiver 18, or a sinking member may be used in place of float 20, or orifices 28 may be omitted or plugged. Moreover, the sinking member or float 20 may be colored to render it highly visible by day or night or camouflaged, as desired. Other treatments for the components of splice system 10 include protection against ultraviolet light.

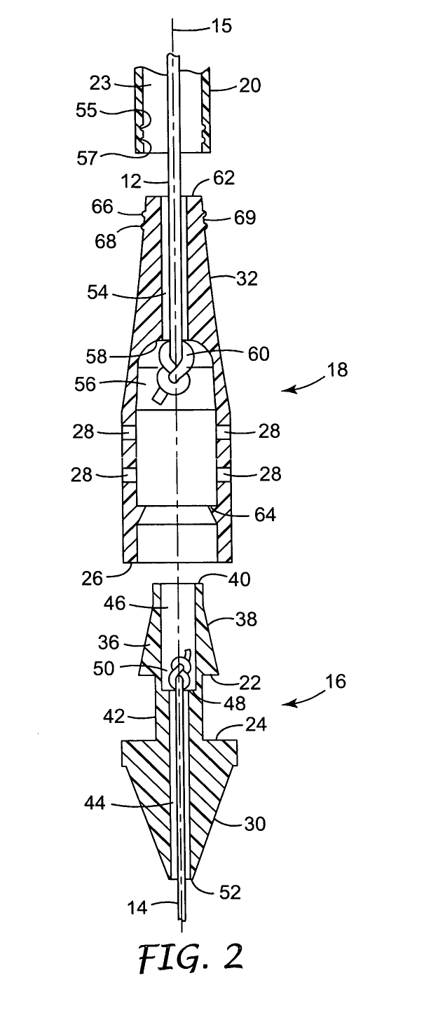

FIG. 2 is a cross-sectional view along line 2-2 of FIG. 1, showing the two connectors of the splice system in a disconnected configuration. In an exemplary embodiment, all features of barb 16 and receiver 18 are symmetrically disposed about axis 15. Barb 16 includes projection 36, which is symmetric about axis 15. Projection 36 has tapered surface 38 having a narrow width at first end 40 of barb 16 and gradually widening to terminate at radial shoulder 22. A narrow neck 42 is disposed on barb 16 between radial shoulder 22 and stop surface 24. In one embodiment, barb 16 includes axial bore 44 and cavity 46 which intersect at interior radially extending shoulder 48. In an exemplary embodiment, axial bore 44 is large enough to allow the passage of leader 14 but not wide enough to allow the passage of knot 50 in leader 14. In an exemplary embodiment, cavity 46 is wide and deep enough to accommodate knot 50. In the illustrated embodiment, leader 14 is removably connected to barb 16. A user threads leader 14 through axial bore 44 from second end 52 of barb 16 to first end 40 of barb 16. After pulling leader 14 through first end 40, the user ties the end of leader 40 into knot 50. If leader 14 extends beyond knot 50, the user can trim off the extra length if desired. Then, the user pulls back on leader 14 to seat knot 50 against shoulder 48.

In the illustrated embodiment, receiver 18 includes axial bore 54 and cavity 56, which intersect at shoulder 58. Axial bore 54 is large enough to allow the passage of fly line 12 but not wide enough to allow the passage of knot 60 formed at the end of fly line 12. In one embodiment, axial bore 52 has a diameter of between about 0.030 inch (0.76 mm) and about 0.050 inch (1.27 mm). Additionally, cavity 56 is wide enough to accommodate knot 60 and deep enough to accommodate knot 60 and protrusion 36 of barb 16. To attach fly line 12 to receiver 18, a user threads fly line 12 from first end 62 of receiver 18 through second end 26. The user than ties knot 60 in fly line 12. If excess fly line 12 extends beyond knot 60, the user can trim off the extra length if desired. The user then pulls fly line 12 back in the direction of first end 62 to seat knot 60 against shoulder 58. With fly line 12 thereby connected to receiver 18 and leader 14 connected to barb 16, fly line 12 and leader 14 can be connected to each other by moving projection 36 of barb 16 along axis 15 into cavity 56 of receiver 18. A permanent snap connection is facilitated by inserting radial shoulder 22 of barb 16 past an interior feature such as raised annulus 64 on the interior surface of receiver 18. Fly line 12 and leader 14 are beneficially aligned along axis 15 to facilitate smooth and predictable movement through air and water.

In one embodiment, barb 16 and receiver 18 include tapered surfaces 30 and 32, respectively, to enhance the movement of splice system 10 through air and water. Tapered surface 30 is symmetric about axis 15 and extends from a narrow diameter near second end 52 of barb 16 to a greater diameter toward stop surface 24. Tapered surface 32 is symmetric about axis 15 and extends from a narrow diameter near first end 62 of receiver 18 to a greater diameter toward second end surface 26.

In one embodiment, receiver 18 also includes exterior raised annuli 66 and 68 forming an annular groove 69 therebetween on the exterior of the receiver 18. Annuli 66 and 68 are provided to facilitate gripping and also for mating with grooves 55 and 57 of float 20 to positionally fix slidably mounted float 20. In another embodiment, a depressed or recessed annular groove is provided on the exterior of receiver 18 to mate with a corresponding raised annulus on float 20. In yet another embodiment, receiver 18 and float 20 have smooth surfaces at their interface and remain attached by friction.

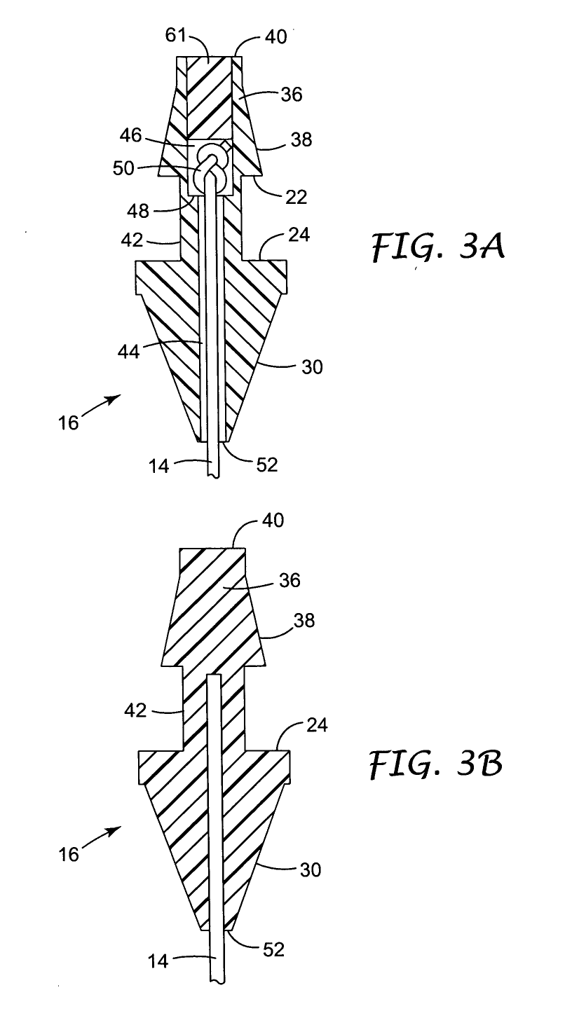

FIG. 3A is a cross-sectional view of another embodiment of barb 16. In the illustrated embodiment, leader 14 is attached to barb 16 during manufacturing with knot 50 or similar mechanism. Filler or plug 61 is inserted during manufacture to permanently secure leader 14 in barb 16.

FIG. 3B is a cross-sectional view of yet another embodiment of a connector of the splice system. In the illustrated embodiment, leader 14 is integrally formed with barb 16 so that axial bore 44, cavity 46 and knot 50 are eliminated. This can be accomplished, for example, by molding barb 16 over leader 14 so that they form an inseparable unit.

FIG. 4 is a cross-sectional view of the two connectors and float 20 of FIG. 2 in a connected configuration. In one exemplary embodiment, as projection 36 is advanced from end 26 of receiver 18 past interior annulus 64, tapered surface 38 of projection 36 facilitates a resilient expansion of the diameter of annulus 64 to allow the passage of projection 36 axially past annulus 64. A radial extent, such as half of an outer diameter, of radial shoulder 22 of projection 36 is greater than a radial extent, such as half of an inner diameter, of annulus 64 in an unexpanded state. When radial shoulder 22 has passed annulus 64, an audible snap or click is heard as annulus 64 resiliently returns to its unexpanded dimension. In particularly suitable embodiments, either one or both of projection 36 and annulus 64 resiliently deform to allow radial shoulder 22 to move past annulus 64 and then return to about the original dimension. Such resilient deformation can be accomplished by the choice of materials and the geometry of barb 16 and receiver 18.

Annulus 64 has a tapered surface 63 to facilitate the advance of projection 36 into cavity 56. In an exemplary embodiment, annulus 64 has a flat surface 65 which projects radially inward and faces radial shoulder 22 to prevent radial shoulder 22 from slipping back past annulus 64. An outer diameter of radial shoulder 22 is slightly larger than an inner diameter of cavity 56 at flat surface 65 of annulus 64 to facilitate an interference fit of projection 36 in receiver 18, thereby leading to an even more secure connection. In a particularly suitable embodiment, flat surface 65 is slightly undercut (i.e., moving radially outward from axis 15, flat surface 65 slopes toward end surface 26) so that annulus 64 forms an annular barb which further prevents the disconnection of barb 16 and receiver 18.

After projection 36 has passed annulus 64, stop surface 24 of barb 16 contacts end surface 26 of receiver 18, and barb 16 and receiver 18 are fully engaged. Cavity 56 is sized to allow for the insertion of projection 36 without interference with knot 60. After the connection of barb 16 and receiver 18, knot 60 is trapped within splice system 10. Because the outer diameter of radial shoulder 22 is greater than the inner diameter of annulus 64, the passage of projection 36 into cavity 56 forms a permanent and strong connection between barb 16 and receiver 18, thereby connecting leader 14 and fly line 12. In an exemplary embodiment, projection 36 at first end 40 has an outside diameter of about 0.090 inch (2.29 mm); projection 36 at radial shoulder 22 has an outside diameter of about 0.120 inch (3.05 mm); bore 56 has a largest unexpanded inner diameter of about 0.106 inch (2.69 mm); and annulus 64 has an unexpanded inner diameter of about 0.094 inch (2.39 mm). In each instance, a radial extent is half of the diameter.

In an exemplary embodiment, the materials and dimensions of barb 16 and receiver 18 are chosen so that barb 16 and receiver 18 cannot be separated with manual tensile or separation force along axis 15 of at least about 8 pounds (3.6 kg). In an especially suitable embodiment, barb 16 and receiver 18 cannot be separated with tensile or separation force along axis 15 of at least about 10 pounds (4.5 kg). Nylon is an especially suitable material for barb 16 and receiver 18 because it swells slightly in water, leading to an even stronger interference connection between barb 16 and receiver 18. In one embodiment, an adhesive such as a water-activated adhesive, may be disposed in cavity 56 or on the surface of projection 36 to further adhere barb 16 and receiver 18 together.

To initially use splice system 10, a user first attaches leader 14 to barb 16 with knot 50 as discussed above with reference to FIG. 2. If barb 16 is of the type illustrated in FIG. 3A or FIG. 3B, this step is omitted. If float 20 is used, a user strings fly line 12 through bore 23 of float 20. The user attaches fly line 12 to receiver 18 as discussed above. Float 20 is secured onto receiver 18 by engaging grooves 55 and 57 of float 20 with annuli 66 and 68 of receiver 18, respectively. The user attaches leader 14 to fly line 12 by inserting barb 16 into receiver 18 to form a permanent, locked connection.

To replace leader 14 with a different leader 14, the user removes the old leader 14 by cutting fly line 12 at severance point 70. Leader 14 can be discarded along with barb 16, receiver 18 and the knotted end of fly line 12. The user can take the new severed end of fly line 12 and attach it to a new receiver 18 by inserting it through axial bore 54 and tying knot 60 as explained above. Thus, a fisher should be supplied with multiple receivers 18 and multiple sets of leaders 14 with attached barbs 16.

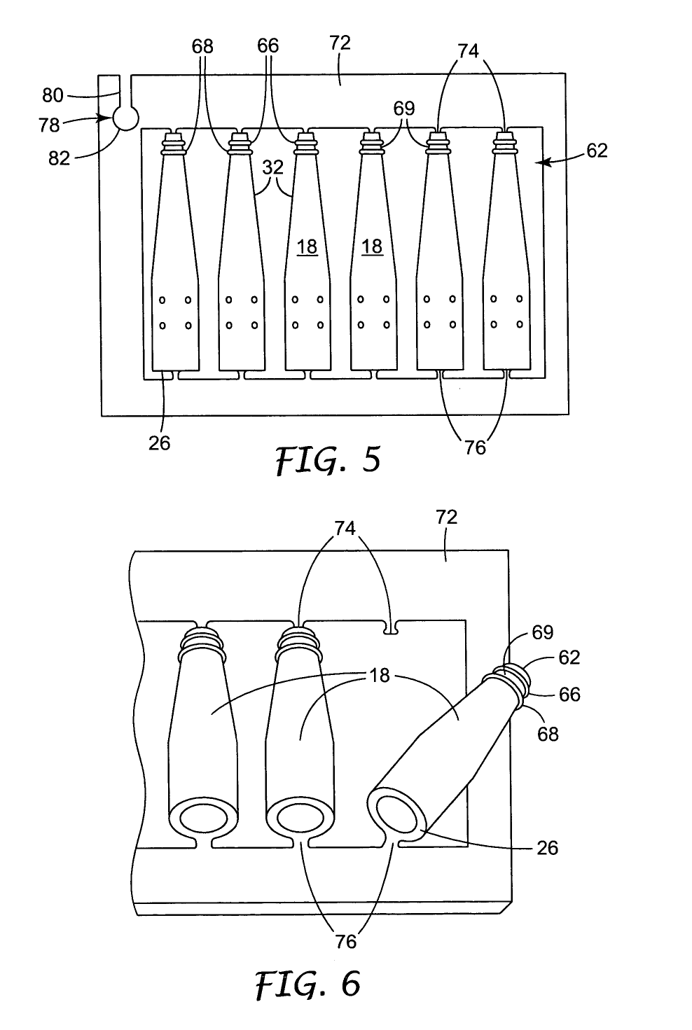

FIG. 5 is a side elevation view of a card holding multiple female connectors 18. Card 72 provides for convenient storage of, and easy accessability to, receivers 18. Card 72 is easily stored in a user=s vest pocket, providing a convenient storage unit for receivers 18, which might otherwise be easily lost because of their small size. An added convenience is that a user can thread fly line 12 through receiver 18 and tie knot 60 while the receiver 18 is held on card 72, thus reducing the risk of dropping and losing the receiver 18 while tying on fly line 12. In one embodiment, receivers 18 are integrally molded with card 72, leaving connecting members 74 and 76 at end 62 and end 26 of each receiver 18, respectively.

FIG. 6 is a partial perspective view illustrating the removal of one receiver 18 from card 72. In one embodiment, each connecting member 74 and 76 secures the respective receiver 18 to card 72 during routine handling, but is easily broken with manual force for the removal of a receiver 18 from card 72.

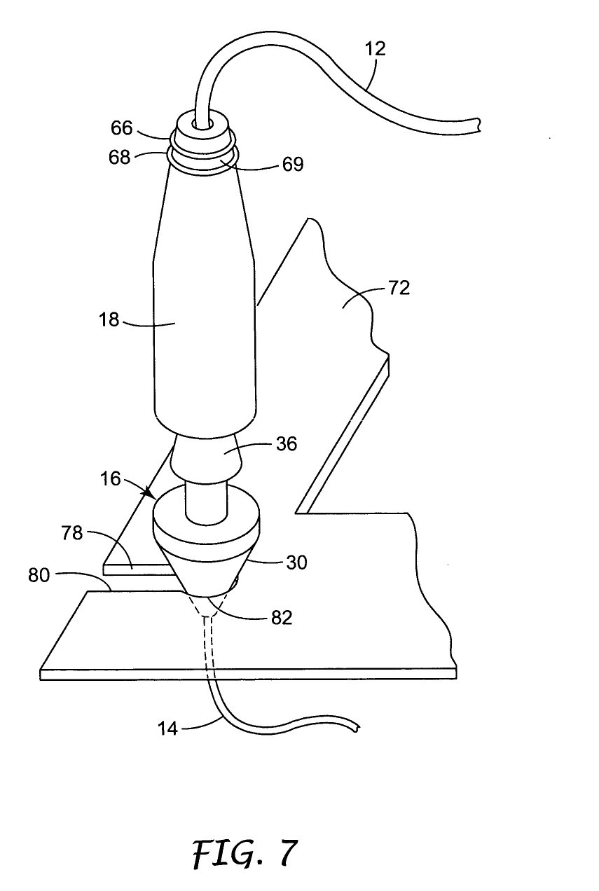

FIG. 7 is a partial perspective view illustrating use of a tool 78 disposed on card 72. In one embodiment, tool 78 includes slot 80 and a slot terminus. In the illustrated embodiment, the slot terminus is a circular bore 82. Tool 78 can be used to facilitate the insertion of projection 36 of barb 16 into receiver 18. In one method of use, a user slides leader 14 through slot 80 to bore 82 so that tapered surface 30 of barb 16 rests in bore 82. With barb 16 thus held, the user can then force receiver 18 onto projection 36 to snap barb 16 and receiver 18 together. Tool 78 is especially helpful because of the difficulty of handling a very small barb 16 and the amount of force necessary to force projection 36 of barb 16 past interior raised annulus 64 of receiver 18. In an exemplary embodiment, bore 82 has a diameter of about 0.116 inch (2.95 mm) and slot 80 has a width of about 0.053 inch (1.35 mm).

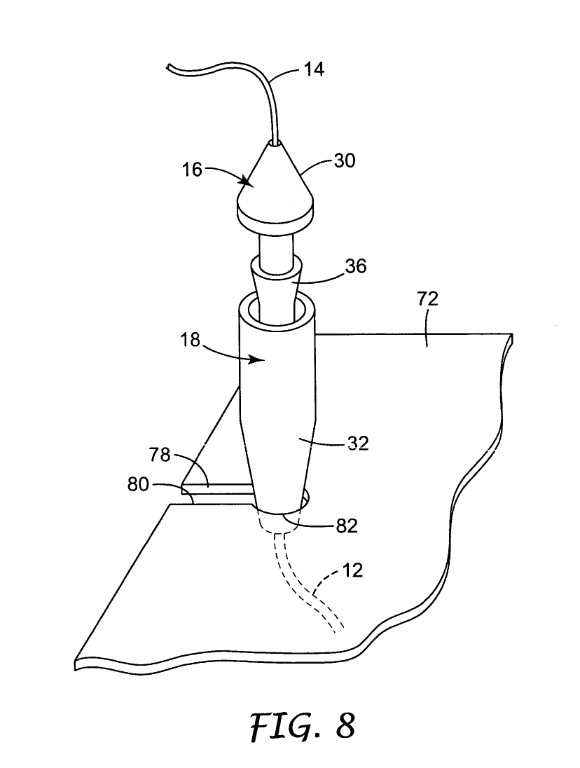

FIG. 8 is a partial perspective view illustrating use of a connector holding tool disposed on the card of FIG. 5 and an alternate method. In the method illustrated in FIG. 8, tapered surface 32 of receiver 18 is inserted into bore 82 of tool 78. In this embodiment, card 72 holds receiver 18 to facilitate the insertion of barb 16 into receiver 18. Because barb 16 and receiver 18 are very small, it can be difficult for a user to manually apply the force required to connect barb 16 and receiver 18, even with the use of tool 78. Therefore, in one embodiment, a lever arm is provided with a card to provide an additional tool to facilitate the application of an adequate amount of force.

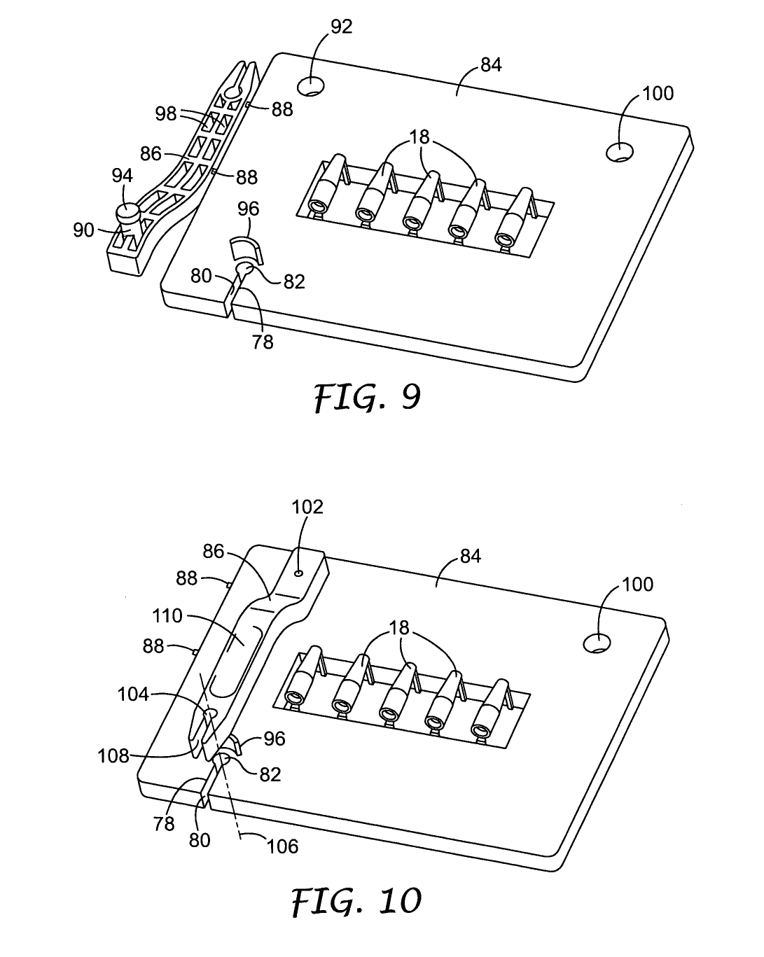

FIG. 9 is a perspective view of a card having an attached lever. Card 84 includes lever 86 attached to card 84 by connecting members 88. In one embodiment, connecting members 88 are small tabs which can be easily broken with ordinary manual force. In one embodiment, lever 86 is integrally molded with card 84. In an alternate embodiment, other attachment means may be used, or lever 86 can be unattached to card 84. In an exemplary embodiment, card 84 is about 3⅜ inches (85.72 mm) long, about 2½ inches (63.50 mm) wide and has a thickness of about ⅛ inch (3.18 mm). In an exemplary embodiment, lever 86 has a length of about 2.32 inches (58.93 mm), a width of about 0.27 inch (6.86 mm) and a thickness of about 0.20 inch (5.08 mm).

In one embodiment, lever 86 includes protrusion 90 for insertion into orifice 92 to attach lever 86 to card 84. While protrusion 90 is illustrated as a cylindrical peg, it is understood that other shapes can be used. Protrusion 90 preferably includes a flange or clip member 94, where either or both of clip member 94 or orifice 92 is resiliently deformable so that clip member 94 is able to pass through orifice 92 to allow insertion of protrusion 90 therethrough, yet prevent unintentional separation of protrusion 90 from card 84. In an exemplary embodiment, protrusion 90 is cylindrical and has a diameter of about 0.149 inch (3.78 mm) and clip member 94 is cylindrical and has a diameter of about 0.158 inch (4.01 mm). In an exemplary embodiment, bore 92 has a diameter of about 0.150 inch (3.81 mm).

In one embodiment, card 84 includes ridge 96 to prevent damage to barb 16 or receiver 18. In one embodiment, lever 86 is not formed of a solid mass but is rather formed with cavities 98 to allow for savings in materials and weight. In one embodiment, card 84 includes orifice 100 as an attachment means to allow a user to secure card 84 to the user=s clothing, for example.

FIG. 10 is a perspective view of the card of FIG. 9 with the lever detached therefrom and then assembled onto the card. To use lever 86 to facilitate the attachment of barb 16 and receiver 18, a user uses manual force to break connecting members 88, thereby detaching lever 86 from card 84. Lever 86 is turned over and protrusion 90 is inserted into orifice 92. Lever 86 includes slot 108 and a slot terminus to allow for the insertion of barb 16 and leader 14 in one method of use. In the illustrated embodiment, the slot terminus is a circular bore 104. Where protrusion 90 is cylindrical and orifice 92 is a circular bore, lever 86 is pivotally attached to card 84 about pivot point 102. In such an embodiment, lever 86 is pivotable about pivot point 102, allowing for alignment of bore 104 of lever 86 vertically above bore 82 of tool 78, along axis 106. Axis 106 is substantially perpendicular to both slot 80 and slot 108. In one embodiment, lever 86 includes depression 110 on a top surface thereof to indicate to a user a location on lever 86 on which the user can press to attach barb 16 and receiver 18. In an exemplary embodiment, a height difference between a bottom surface of lever 86 and a top surface of card 84 is about 0.34 inch (8.64 mm). In an exemplary embodiment, bore 104 tapers from a diameter of about 0.113 inch (2.87 mm) on a bottom surface of lever 86 to a diameter of about 0.088 inch (2.24 mm) on a top surface of lever 86. In an exemplary embodiment, slot 108 is about 0.046 inch (1.17 mm) wide.

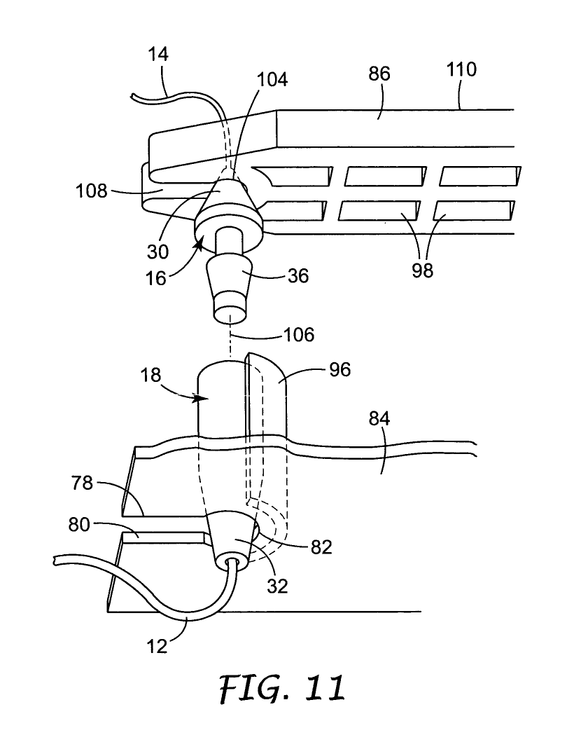

FIG. 11 is a perspective view showing one embodiment of a method for assembling the splice system using the lever and card tool. To use lever 86 and tool 78 on card 84 to facilitate the attachment of barb 16 and receiver 18, in one embodiment, a user slides fly line 12 of receiver 18 through slot 80 to seat tapered surface 32 of receiver 18 within bore 82. In this embodiment, a user also slides leader 14 of barb 16 through slot 108 of lever 86 to seat tapered surface 30 of barb 16 within bore 104 of lever 86. This can be achieved more easily if the user initially pivots lever 86 away from axis 106. Once receiver 18 and barb 16 are seated in their respective bores 82 and 104, the user can pivot lever 86 into position to align barb 16 and receiver 18 along axis 106. The user then provides manual force at depression 110 of lever 86 to force barb 16 and receiver 18 together along axis 106.

In one embodiment, ridge 96 is provided on card 84 proximate bore 82 to serve as a stop member for lever 86. In this function, ridge 96 prevents excessive downward force on lever 86 from damaging the connected splice system 10 of barb 16 and receiver 18. While the method illustrated in FIG. 11 shows the same connection orientation as FIG. 8, it is understood that the orientation of barb 16 and receiver 18 can also be reversed, as shown in FIG. 7.

Although the present invention has been described with reference to preferred embodiments, workers skilled in the art will recognize that changes may be made in form and detail without departing from the spirit and scope of the invention.

1. A fishing line splice tool comprising:
a card having a first slot, the first slot having a first terminus; and
a lever having a second slot, the second slot having a second terminus, wherein the second terminus and the first terminus can be aligned along an axis, the axis being substantially perpendicular to both the first slot and the second slot.

2. The tool of claim 1 wherein each of the first and second termini are circular bores.

3. The tool of claim 1 wherein the card and the lever are integrally molded.

4. The tool of claim 1 wherein the card and the lever are detachably connected.

5. The tool of claim 1 wherein the lever is attachable to the card.

6. The tool of claim 5 wherein:
the card comprises an orifice; and
the lever comprises a protrusion which is insertable into the orifice to attach the lever to the card.

7. The tool of claim 6 wherein:
the orifice is a circular bore; and
the protrusion is a cylindrical peg.

8. The tool of claim 7 wherein the protrusion further comprises a clip member.

9. The tool of claim 1 wherein the lever comprises a plurality of cavities.

10. The tool of claim 1 wherein the lever comprises a depression on a top surface of the lever.

11. The tool of claim 1 wherein the card further comprises:
a ridge proximate the first terminus.

12. A method for linear connection of fishing lines comprising:
providing a female connector having first and second opposite ends and a longitudinal axis, the first end connected to a first fishing line section and the second end having a first opening therein, the female connector having an interior feature with a radial extent;
providing a male connector having first and second opposite ends and a longitudinal axis, the second end connected to a second fishing line section and the first end having a projection thereon configured for coaxial insertion into the first opening of the female connector, the projection having a radial extent greater than the radial extent of the interior feature of the female connector;
providing a card having a first slot, the first slot having a first terminus;
inserting the first end of the female connector into the first terminus to thereby hold the female connector;
inserting the male connector into the first opening of the female connector; and
moving the radial extent of the projection of the male connector axially past the interior feature of the female connector.

13. The method of claim 12 further comprising:
providing a lever having a second slot, the second slot having a second terminus; and
inserting the second end of the male connector into the second terminus to thereby hold the male connector prior to inserting the male connector into the first opening of the female connector.

14. The method of claim 13 further comprising:
aligning the male connector and the female connector prior to inserting the male connector into the first opening of the female connector.

15. The method of claim 14 in which the step of aligning the male connector and the female connector includes pivoting the lever.

16. The method of claim 13 wherein the step of inserting the male connector into the first opening of the female connector includes providing manual force on the lever.

17. A method for linear connection of fishing lines comprising:
providing a female connector having first and second opposite ends and a longitudinal axis, the first end connected to a first fishing line section and the second end having a first opening therein, the female connector having an interior feature with a radial extent;
providing a male connector having first and second opposite ends and a longitudinal axis, the second end connected to a second fishing line section and the first end having a projection thereon configured for coaxial insertion into the first opening of the female connector, the projection having a radial extent greater than the radial extent of the interior feature of the female connector;
providing a card having a first slot, the first slot having a first terminus;
inserting the second end of the male connector into the first terminus to thereby hold the male connector;
inserting the male connector into the first opening of the female connector; and
moving the radial extent of the projection of the male connector axially past the interior feature of the female connector.

18. The method of claim 17 further comprising:
providing a lever having a second slot, the second slot having a second terminus; and
inserting the first end of the female connector into the second terminus to thereby hold the female connector prior to inserting the male connector into the first opening of the female connector.

19. The method of claim 18 further comprising:
aligning the male connector and the female connector prior to inserting the male connector into the first opening of the female connector.

20. The method of claim 18 wherein the step of inserting the male connector into the first opening of the female connector includes providing manual force on the lever.

21. A splice system for linear connection of fishing lines, the system comprising:
a female connector having first and second opposite ends and a longitudinal axis, the connector being symmetric about the axis, the first end connected to a first fishing line section and the second end having a first opening therein, the first end having a tapered exterior surface, the connector having an interior feature with a radial extent; and
a male connector having first and second opposite ends and a longitudinal axis, the connector being symmetric about the axis, the second end connected to a second fishing line section and the first end having a projection thereon configured for coaxial insertion into the first opening of the female connector, the projection having a radial extent greater than the radial extent of the interior feature of the female connector;
wherein at least one of the connectors is resilient so that the projection compresses or the interior feature expands to allow passage of the projection axially past the interior feature.
